(19) United States
(12) Patent Application Publication
(10) Pub. No.: US 2006/0283982 A1
(43) Pub. Date: Dec. 21, 2006

(54) Head adjustable watering wands

(76) Inventor: King-Yuan Wang, Chang-Hua (TW)

Correspondence Address: KING-YUAN WANG, P.O. BOX 487, CHANG-HUA CITY, 500, TW

(21) Appl. No.: 11/153,372

(22) Filed: Jun. 16, 2005

(51) Int. Cl. B05B 9/08; B05B 15/08

(52) U.S. Cl. 239/530; 239/532; 239/587.5

(57) ABSTRACT

A watering wand includes a long tube and a connection frame connected to an end of the long tube, a rotatable member and a head are connected to the connection frame. A connection member and a guide tube are connected to the other end of the long tube. The guide tube has a moving piece movably received therein and the moving piece includes a radial extension which is movably engaged with an axial slot. defined in the guide tube. A sleeve with a spiral groove is mounted to the guide tube and the radial extension is movably engaged with the spiral groove. A link has an end thereof fixed to the rotatable member and the other end of the link is fixed with the moving piece, so that when rotating the sleeve, the link is pulled to rotate the rotatable member such that the head is rotated. A watering nozzle is connected to the head and is able to water different positions by simply rotating the sleeve.

### FIELD OF THE INVENTION

The present invention relates to a watering wand, and more particularly to a head adjustable watering wand.

### BACKGROUND OF THE INVENTION

A conventional watering wand generally includes a long tube with a watering head connected to a remote end of the long tube, a hose is connected to the long tube so as to watering plants located at higher positions. The head is generally fixed to the long tube by adhesive so that the uses have to raise the head above the plants and rotate the long tube to adjust the head above the plants one by one. When the plants are hanged in a row, the users then have to water the plant on the right and then rotate the long tube to move the head to the plant on the left. This procedure requires a lot of muscle actions and might hurt the users' hands if a certain number of rotating the long tube is proceeded.

The present invention intends to provide a watering wand that includes an adjustable head which is rotated by rotating a sleeve close to the user's hand so that the user simply operates the sleeve to change the directions of the head without rotating the whole watering wand.

### SUMMARY OF THE INVENTION

The present invention relates to a watering wand which comprises a long tube with and a connection frame connected to an end of the long tube. A. rotatable member and a head are connected to the connection frame. A connection member and a guide tube are connected to the other end of the long tube. The guide tube has a moving piece movably received therein and the moving piece has a radial extension which is movably engaged with an axial slot in the guide tube. A sleeve is mounted to the guide tube and has a spiral groove defined in an inner periphery thereof. The radial extension is movably engaged with the spiral groove. A link extends through the long tube and an end of the link is fixed to the rotatable member. The other end of the link is fixed with the moving piece. The link is pulled by rotating the sleeve and the rotatable member is then rotated by the link and the head is rotated by the rotation of the rotatable member. A watering nozzle is connected to the head so that the watering nozzle can be rotated to water different positions of plants.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a watering wand of the present invention;

FIG. 2 is a side view of the watering wand of the present invention;

FIG. 3 is a cross sectional view to show watering wand of the present invention;

FIGS. 4 and 5 show two different angles of the connection of the head and the rotatable member, and

FIG. 6 shows that the head is rotatable about the bolt.

### DETAILED DESCRIPTION OF THE PREFERRED EMBODIMENT

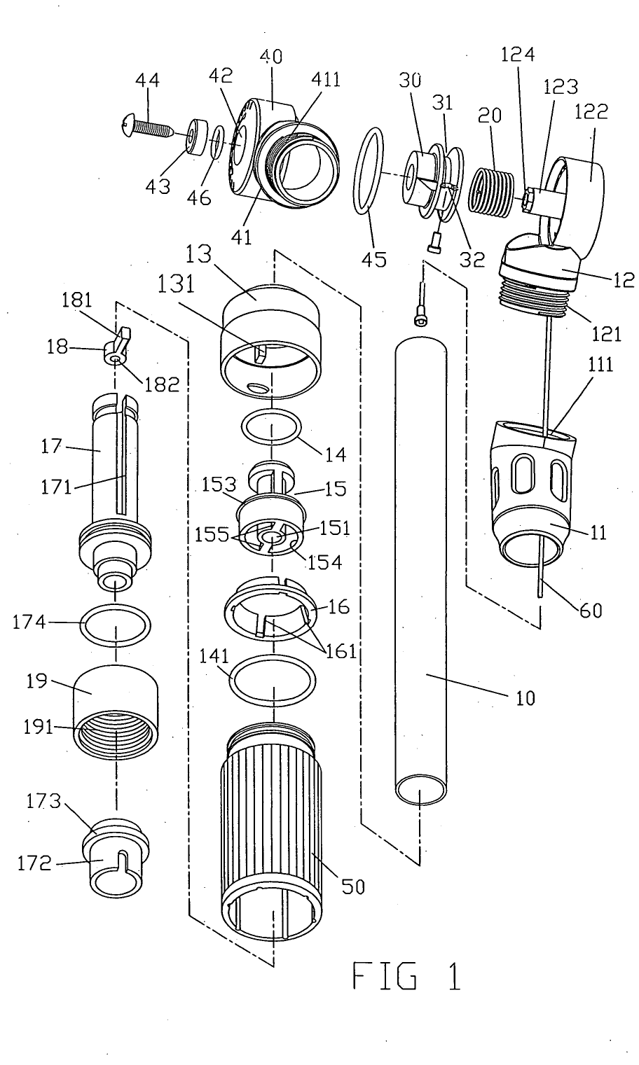

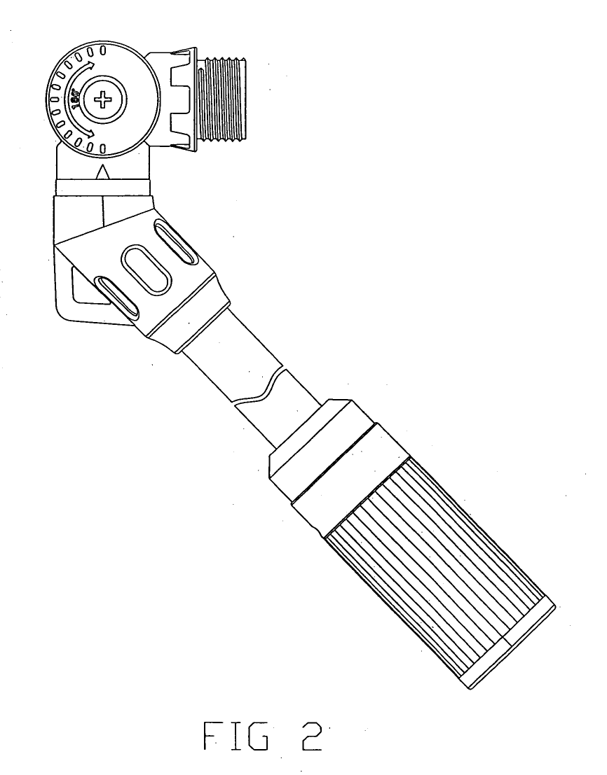

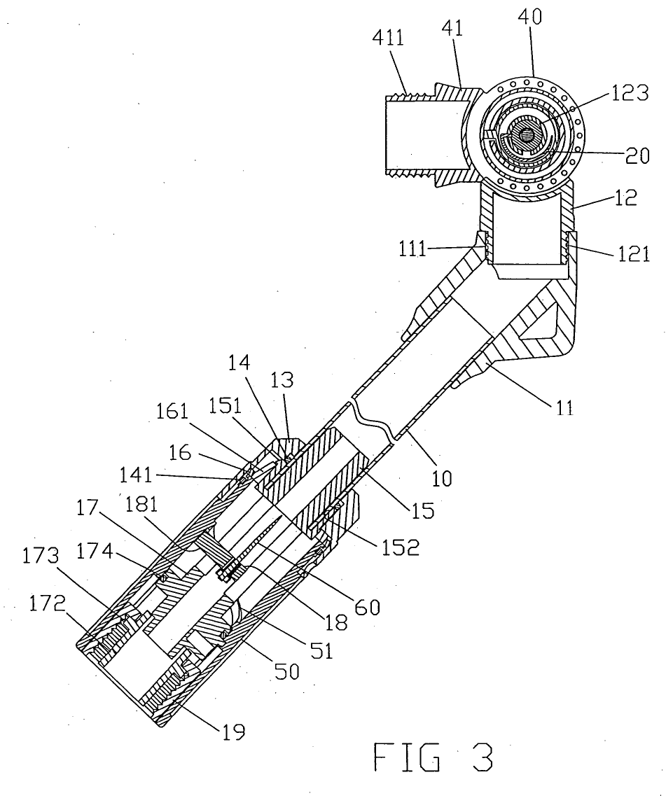

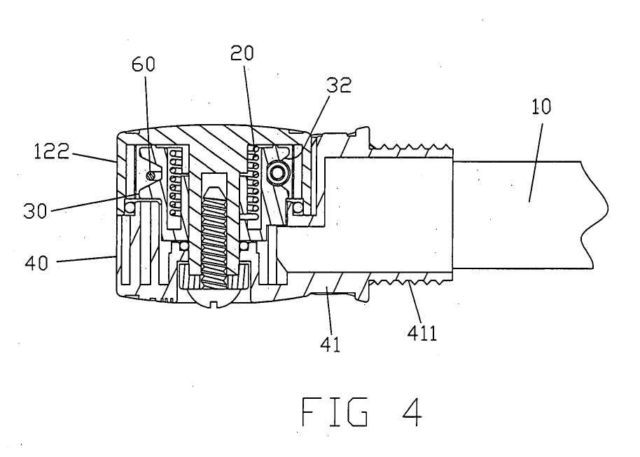

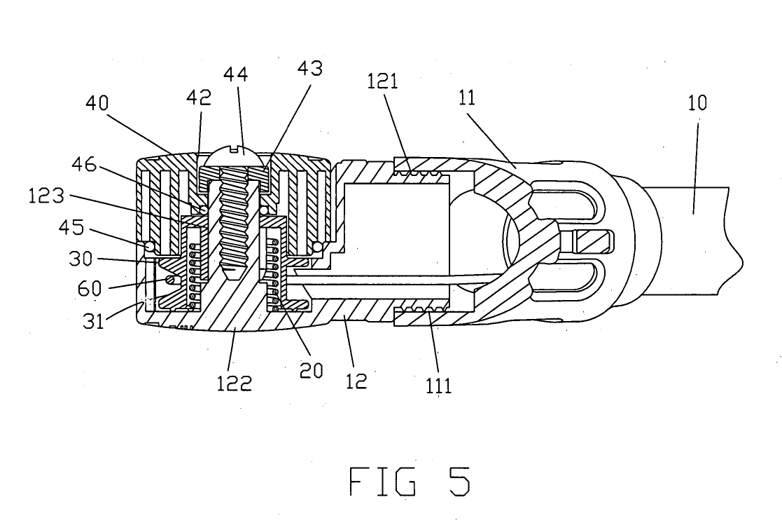

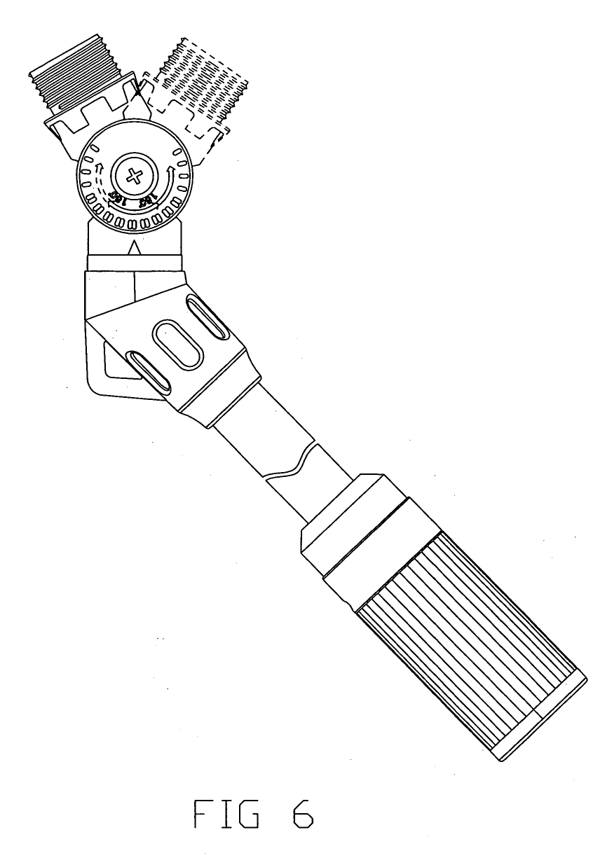

Referring to FIGS. 1 to 5, the watering wand of the present invention comprises a long tube 10 and a connection tube 11 is fixed to an end of the long tube 10. The connection tube 11 has an inner threaded periphery 111 so as to be threadedly connected to an outer threaded periphery 121 of the connection frame 12. The rotatable frame 12 includes a transfer frame 122 which includes a connection rod 123 extending therefrom. A torsion spring 20, the rotatable member 30 and the head 40 are mounted to the transfer rod 123. The torsion spring 20 is located between the transfer frame 122 and the rotatable member 30. Two ends of the torsion spring 20 are respectively fixed to the transfer frame 122 and the rotatable member 30. An axis of the transfer rod 123 is perpendicular to an axis of the connection frame 12 so that the head 40 is perpendicular to the axis of the long tube 10. The rotatable member 30 includes an annular groove 31 defined in an outer periphery thereof and a connection flange 32 is located in the annular groove 31.

The head 40 includes a connection portion 41 which extends from the head 40 at an angle, ninety degrees for example, the connection portion 41 has an outer threaded periphery 411 so as to be connected to a watering nozzle for example which is not shown. The transfer rod 123 includes a threaded hole 124 defined in a distal end thereof and the head 40 includes a receiving space 42 in an axial direction. An end piece 43 is received in the receiving space 42 and a bolt 44 extends through the end piece 43 and is threadedly engaged with the threaded hole 124 in the transfer rod 123. A seal 46 is located between the end piece 43 and the inside of the receiving space 42 to prevent leakage. Another seal 45 is located between the transfer frame 122 and the head 40.

A connection member 15 and a guide tube 17 are connected to the other end of the long tube 10. The guide tube 17 has two axial slots 171 and a moving piece 18 is movably received in the guide tube 17. The moving piece 18 has a radial extension 181 which is movably engaged with one of the axial slots 171. A sleeve 50 is mounted to the guide tube 17 and has a spiral groove 51 defined in an inner periphery thereof. The radial extension 181 is movably engaged with the spiral groove 51. Before assembling the guide tube 17, an upper collar 13, a connection member 15 and a positioning collar 16 are mounted to the guide tube 17. The upper collar 13 includes a plurality of positioning pieces 131 on an inner periphery thereof and the positioning collar 16 includes a plurality of slots 161 with which the positioning pieces 131 are engaged. The connection member 15 includes an axial passage 151 and a recess 152 is defined in an underside of the connection member 15 so that the long tube 10 is engaged with the recess 152. A lip 153 extends from an outer periphery of the connection member 15 and the positioning collar 16 is stopped by the lip 153. Two ribs 155 extend from an outer periphery of the passage 151 so as to define insertion holes 154 in which the guide tube 17 is inserted and the ribs 155 are engaged with the axial slots 171 of the guide tube 17. An upper end of the sleeve 50 is inserted in the upper collar 13.

A link 60 which can be a steel cable, a stripe or a wire, extends through the long tube 10 and an end of the link 60 is fixed to the connection flange 32 of the rotatable member 30, the other end of the link 60 extends through the passage 151 of the connection member 15 and a through hole 182 of the moving piece 18 and is fixed to an end piece so that the link 60 is fixed with the moving piece 18. The link 60 can also go from outside of the long tube 10.

In order to prevent leakage, a seal 14 is located between the upper collar 13 and the long tube 10. Another seal 141 is located between the upper collar 13 and the sleeve 50. A further seal 141 is located between the sleeve 50 and the guide tube 17.

When rotating the sleeve 50, the moving piece 18 is moved up and down to pull the link 60 which rotates the rotatable member 30 so as to rotate the head 40 and the watering nozzle (not shown) about the bolt 44 to water different positions. When releasing the sleeve 50, the torsion spring 20 spins the rotatable member 30 backward.

While we have shown and described the embodiment in accordance with the present invention, it should be clear to those skilled in the art that further embodiments may be made without departing from the scope of the present invention.

What is claimed is:

1. A watering wand comprising:
a long tube and a connection frame connected to an end of the long tube, a rotatable member and a head connected to the connection frame, a connection member and a guide tube connected to the other end of the long tube, the guide tube having an axial slot and a moving piece movably received in the guide tube, the moving piece having a radial extension which is movably engaged with the axial slot, a sleeve mounted to the guide tube and having a spiral groove defined in an inner periphery thereof, the radial extension movably engaged with the spiral groove, a link extending through the long tube and an end of the link fixed to the rotatable member, the other end of the link fixed with the moving piece, the link being pulled by rotating the sleeve and the rotatable member being rotated by the link and the head being rotated by the rotation of the rotatable member.

2. The wand as claimed in claim 1, wherein a connection tube is fixed to the long tube and has an inner threaded periphery, the connection frame includes an outer threaded periphery which is engaged with inner threaded periphery of the connection tube.

3. The wand as claimed in claim 1, wherein the rotatable frame includes a transfer frame which includes a connection rod, a torsion spring, the rotatable member and the head are mounted to the transfer rod.

4. The wand as claimed in claim 3, wherein the torsion spring is located between the transfer frame and the rotatable member, two ends of the torsion spring are respectively fixed to the transfer frame and the rotatable member.

5. The wand as claimed in claim 3, wherein an axis of the transfer rod is perpendicular to an axis of the connection frame.

6. The wand as claimed in claim 1, wherein the rotatable member includes an annular groove defined in an outer periphery thereof and a connection flange is located in the annular groove so as to be connected with the link.

7. The wand as claimed in claim 1, wherein the head includes a connection portion which extends from the head at an angle, the connection portion has an outer threaded periphery.

8. The wand as claimed in claim 1, wherein the transfer rod includes a threaded hole defined in a distal end thereof and a head includes a receiving space in an axial direction, an end piece is received in the receiving space and a bolt extends through the end piece and is threadedly engaged with the threaded hole in the transfer rod.

9. The wand as claimed in claim 1, wherein an upper collar, a connection member and a positioning collar are mounted to the guide tube.

10. The wand as claimed in claim 9, wherein the upper collar includes a plurality of positioning pieces on an inner periphery thereof and the positioning collar includes a plurality of slots with which the positioning pieces are engaged, the connection member includes an axial passage and a recess is defined in an underside of the connection member so that the long tube is engaged with the recess, a lip extends from an outer periphery of the connection member and the positioning collar is stopped by the lip.

11. The wand as claimed in claim 10, wherein at least one rib extends from an outer periphery of the passage so as to define an insertion hole in which the guide tube is inserted and the at least one rib is engaged with the axial slot of the guide tube.

12. The wand as claimed in claim 9, wherein a seal is located between the upper collar and the connection member.

13. The wand as claimed in claim 9, wherein an upper end of the sleeve is inserted in the upper collar.

14. A watering wand comprising:
a long tube and a head is pivotably connected to an end of the long tube, a sleeve connected to the other end of the long tube, a rotatable member rotatably connected to the head, a link connected between the rotatable member connected to the head and the sleeve which is rotated to pull the link.

15. The wand as claimed in claim 14, wherein the link extends through the long tube.

16. The wand as claimed in claim 14, wherein the link is a steel cable.
